(19) United States
(12) Patent Application Publication
(10) Pub. No.: US 2023/0266421 A1
(43) Pub. Date: Aug. 24, 2023

(54) CONTROL DEVICE AND SYSTEM

(71) Applicant: KABUSHIKI KAISHA TOKAI RIKA DENKI SEISAKUSHO, Aichi (JP)

(72) Inventor: Kazuki NAIKI, Aichi (JP)

(73) Assignee: KABUSHIKI KAISHA TOKAI RIKA DENKI SEISAKUSHO, Aichi (JP)

(21) Appl. No.: 18/015,837

(22) PCT Filed: Jul. 1, 2021
(86) PCT No.: PCT/JP2021/024983

§ 371 Date: Jan. 12, 2023

(30) Foreign Application Priority Data
Jul. 27, 2020 (JP) 2020-126284

(51) Int. Cl. G01S 3/46; G01S 3/14

(52) U.S. Cl. CPC G01S 3/46; G01S 3/143

(57) ABSTRACT

Provided is a control device, including a wireless communication unit that has at least two antenna elements and performs wireless communication with another communication device, and a control unit that controls a controlled device on the basis of a direction of the another communication device, the direction being estimated on the basis of the wireless communication, in which the control unit causes the controlled device to perform a given operation when the direction of the another communication device is within a prescribed range.

### TECHNICAL FIELD

The present invention relates to a control device and a system.

### BACKGROUND ART

Recently, there has been developed a technology of performing authentication in accordance with the result of transmission and reception of signals between devices. For example, the following Patent Literature 1 discloses a system in which an on-vehicle device performs authentication of a portable device by transmitting and receiving signals to and from the portable device and controls the vehicle in accordance with the result of the authentication.

### CITATION LIST

### Patent Literature

Patent Literature 1: JP H11-208419A

### SUMMARY OF INVENTION

### Technical Problem

In the above-described system, more complicated authentication conditions are also assumed for further improvement of the security. However, in this case, the power consumption of the on-vehicle device or portable device may increase.

In view of the above-described problem, the present invention aims at suppressing power consumption while ensuring the security.

### Solution to Problem

In order to solve the above-described problem, an aspect of the present invention provides a control device including a wireless communication unit that has at least two antenna elements and performs wireless communication with another communication device, and a control unit that controls a controlled device on the basis of a direction of the another communication device, the direction being estimated on the basis of the wireless communication, in which the control unit causes the controlled device to perform a given operation when the direction of the another communication device is within a prescribed range.

In order to solve the above-described problem, another aspect of the present invention provides a system including a control device and a communication device, in which the control device includes a wireless communication unit that has at least two antenna elements and performs wireless communication with the communication device, and a control unit that controls a controlled device on the basis of a direction of the communication device, the direction being estimated on the basis of the wireless communication, in which the control unit causes the controlled device to perform a given operation when the direction of the communication device is within a prescribed range.

### Advantageous Effects of Invention

As described above, in the present invention, it is possible to suppress power consumption while ensuring the security.

### BRIEF DESCRIPTION OF DRAWINGS

FIG. 1 is a block diagram illustrating a configuration example of a system 1 according to an embodiment of the present invention.

FIG. 2 is a diagram for explaining an example of the control by an on-vehicle device 20 according to the embodiment.

FIG. 3 is a diagram for explaining an example of the control by the on-vehicle device 20 according to the embodiment.

FIG. 4 is a diagram illustrating an arrangement example of an antenna element 225 according to the embodiment.

FIG. 5 is a sequence diagram illustrating an example of a flow of the processing by the system 1 according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### <1. Embodiment>

### <<1.1 System Configuration Example>>

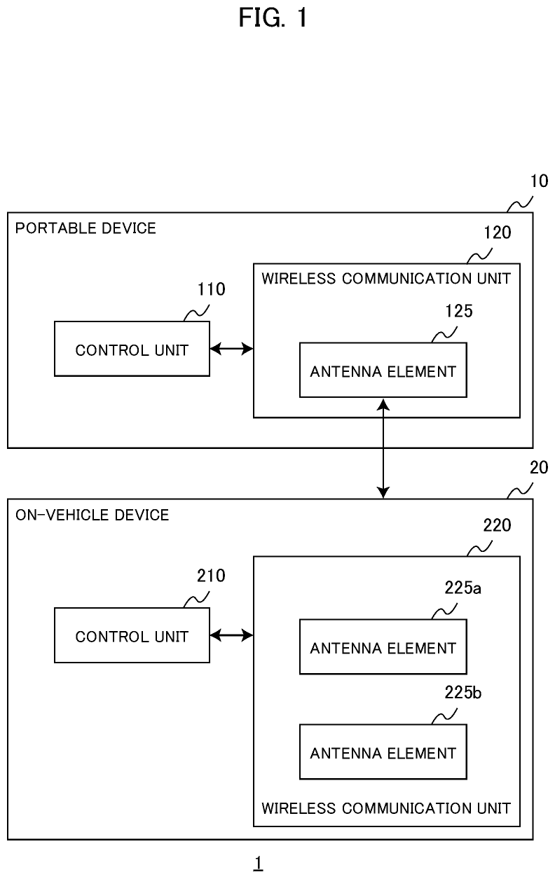

First, a configuration example of the system 1 according to an embodiment of the present invention will be described. FIG. 1 is a block diagram illustrating a configuration example of the system 1 according to the embodiment. As illustrated in FIG. 1, the system 1 of the embodiment includes a portable device 10 and the on-vehicle device 20.

### (Portable Device 10)

The portable device 10 of the embodiment is a communication device carried by a user of a mobile body in which the on-vehicle device 20 is provided. The portable device 10 of the embodiment may be, for example, a smartphone or a dedicated device, for example.

As illustrated in FIG. 1, the portable device 10 of the embodiment includes a control unit 110 and a wireless communication unit 120.

### (Control Unit 110)

The control unit 110 of the embodiment controls the components of the portable device 10. Moreover, the control unit 110 may perform distance measurement for calculating a distance between the portable device 10 and the on-vehicle device 20 (more precisely, a distance between the wireless communication unit 120 and a wireless communication unit 220 of the on-vehicle device 20) on the basis of the result of wireless communication performed between the wireless communication unit 120 and the on-vehicle device 20.

For example, the control unit 110 of the embodiment may measure a distance on the basis of a first signal transmitted by the wireless communication unit 120 and a second signal transmitted by the on-vehicle device 20 in response to the first signal.

To be more specific, the control unit 110 measures a distance on the basis of time ΔT1 from the time when the wireless communication unit 120 transmits a first signal to the time when it receives a second signal, and time ΔT2 from the time when the on-vehicle device 20 receives the first signal to the time when it transmits the second signal.

The control unit 110 is able to calculate the time required for round-trip communication of distance measurement signals by subtracting ΔT2 from ΔT1, and calculate the time required for one-way communication of the distance measurement signals by dividing such time by two. Furthermore, the control unit 110 is able to obtain a distance (hereinafter, referred to as a distance measurement value) between the portable device 10 and the on-vehicle device 20 by multiplying a value of (ΔT1-ΔT2)/2 by a signal speed.

Note that signals using a frequency in an ultra-wide band (UWB) may be used as the above-described first signal and second signal. The signal of an impulse system in the UWB is characterized in being capable of performing positioning and distance measurement with high accuracy. That is, with the use of radio waves having a considerably short pulse width of a nanosecond or shorter, it is possible to measure air propagation time of radio waves with high accuracy and thus perform positioning and distance measurement with high accuracy on the basis of the propagation time.

The functions of the control unit 110 of the embodiment are achieved by various kinds of processors.

### (Wireless Communication Unit 120)

The wireless communication unit 120 of the embodiment performs wireless communication with the on-vehicle device 20. For this purpose, the wireless communication unit 120 of the embodiment includes at least one antenna element 125.

For example, the wireless communication unit 120 of the embodiment transmits the above-described first signal, and receives the second signal. Moreover, the wireless communication unit 120 transmits a distance measurement value calculated by the control unit 110 to the on-vehicle device 20.

The above has described the functional configuration of the portable device 10 of the embodiment. Note that the above-described functional configuration of the portable device 10 is merely an example, and the functional configuration of the portable device 10 of the embodiment is not limited thereto. The functional configuration of the portable device 10 of the embodiment can be modified flexibly depending on specifications and uses.

### (On-Vehicle Device 20)

The on-vehicle device 20 of the embodiment is an example of the control device provided in a mobile body V such as a vehicle. As illustrated in FIG. 1, the on-vehicle device 20 of the embodiment includes a control unit 210 and a wireless communication unit 220.

### (Control Unit 210)

The control unit 210 of the embodiment controls the components of the on-vehicle device 20. Moreover, the control unit 210 controls at least one controlled device provided in the mobile body V.

Moreover, the control unit 210 of the embodiment controls at least one controlled device provided in the mobile body V on the basis of the direction of the portable device with the mobile body V as a reference, the direction being estimated on the basis of wireless communication performed between the wireless communication unit 220 and the portable device 10.

Here, the control unit 210 of the embodiment is characterized in causing the controlled device to perform a given operation when the direction of the portable device is within a prescribed range.

Note that the controlled devices of the embodiment are, for example, a locking device locking and unlocking the doors, an engine, an accelerator, a brake, a steering device, a lighting device, and the like, which are provided in the mobile body V.

For example, when the direction of the portable device 10 is within a prescribed range, the control unit 210 of the embodiment may instruct the locking device to unlock the doors.

Moreover, for example, when the direction of the portable device 10 is within a prescribed range, the control unit 210 of the embodiment may permit the start of the engine.

Moreover, for example, when the direction of the portable device 10 is within a prescribed range, the control unit 210 of the embodiment may control the mobile body V to automatically park at parking space.

Moreover, for example, when the direction of the portable device 10 is within a prescribed range, the control unit 210 of the embodiment turns on a lighting device provided on the lower side of the doors of the mobile body V, thereby assisting a user to get on the mobile body V.

With the control as described above, it is possible to control various kinds of processing in accordance with the direction of the portable device 10 carried by the user, and thus improve the convenience.

Moreover, with the control as described above, it is possible to further improve the security with a simple configuration.

The functions of the control unit 210 of the embodiment are achieved by various kinds of processors.

### (Wireless Communication Unit 220)

The wireless communication unit 220 of the embodiment performs wireless communication with the portable device 10. For example, the wireless communication unit 220 may receive a first signal from the portable device 10 and transmit a second signal in response to the first signal. Moreover, for example, the wireless communication unit 220 may receive distance measurement information such as a distance measurement value from the portable device 10.

Moreover, the wireless communication unit 220 of the embodiment includes at least two antenna elements 225a and 225b. The wireless communication unit 220 may estimate, on the basis of a phase difference related to a signal from the portable device 10 received by the antenna elements 225a and 225b, an angle of arrival (AoA) of the signal.

In this case, the control unit 210 may control a controlled device on the basis of an angle of arrival estimated by the wireless communication unit 220. Specifically, the control unit 210 may cause the controlled device to perform a given operation when the above-described angle of arrival is within a prescribed range.

With the above-described control, it is possible to perform a control in accordance with the direction of the portable device 10, with a simple configuration including at least two antenna elements 225a and 225b, and suppress power consumption while ensuring the security.

The above has described the functional configuration example of the on-vehicle device of the embodiment. Note that the above-described functional configuration of the on-vehicle device 20 is merely an example, and the functional configuration of the on-vehicle device 20 of the embodiment is not limited thereto. The functional configuration of the on-vehicle device 20 of the embodiment can be modified flexibly depending on specifications and uses.

### <<1.2. Details of Functions>>

The following will specifically describe the functions of the system 1 according to the embodiment.

Conventionally, signals in a low frequency (LF) band and an ultra high frequency (UHF) band have been widely used in a method for authenticating a portable device. However, in a case where signals in an LF band and an UHF band are used, there is required, for ensured security, a countermeasure against relay attacks and the like that relay signals of a portable device and illegally establish authentication.

As the above-described countermeasure, there is also assumed a method of measuring a distance between an on-vehicle device and a portable device and performing authentication based on the calculated distance measurement value, for example.

However, in order to accurately perform authentication based on a distance measurement value, it is required to obtain the distance measurement value with high accuracy.

Moreover, as a method for obtaining a high-accuracy distance measurement value, it is also assumed that a plurality of communication units for obtaining distance measurement values are provided in a vehicle so that each communication unit performs distance measurement. However, in this case, the manufacturing cost increases by the number of notification units provided in a vehicle.

Moreover, as another method, it is assumed that distance measurement is performed a plurality of times by a single communication unit. However, even in this case, the power consumption increases as the number of times of distance measurement increases.

The on-vehicle device 20 according to one embodiment of the present invention has been made in view of the above-described aspects, and is capable of suppressing power consumption while ensuring the security.

For this purpose, the control unit 210 of the on-vehicle device 20 according to the embodiment estimates an angle of arrival of a signal transmitted by the portable device 10, and causes a controlled device to perform a given operation when the angle of arrival is within a given range and when the direction of the portable device 10 is within a given range.

With the above-described control, it is possible to eliminate a concern about relay attacks and prevent an increase in power consumption due to distance measurement performed a plurality of times.

Moreover, in addition to the above-described control based on the direction of the portable device 10, the control unit 210 of the on-vehicle unit 20 of the embodiment may cause the controlled device to perform a given operation when a distance between the portable device 10 and the on-vehicle unit 20 estimated on the basis of wireless communication is within a prescribed range.

That is, when the estimated angle of arrival is within a prescribed range, and the distance measurement value is within a prescribed range, the control unit 210 may cause the controlled device to perform a given operation.

With this control, it is possible to perform more secure authentication based on the direction and distance of the portable device 10, and provide more detailed functions in accordance with the direction and distance.

Note that the signals used for calculating an angle of arrival and measuring a distance may be the above-described signals using a frequency in the UWB band. In this case, the antenna elements 225a and 225b receive a first signal transmitted by the portable device 10 for distance measurement, whereby the wireless communication unit 220 is able to estimate an angle of arrival of the first signal, and achieve the above-described control with the smaller number of times of communication.

Meanwhile, signals conforming to mutually different wireless communication standards may be used for calculating an angle of arrival and measuring a distance. In this manner, in a case where the portable device 10 is a smartphone, for example, the above-described control is also possible using Wi-Fi (registered trademark) or BlueTooth (registered trademark) that are usable as standard for the smartphone.

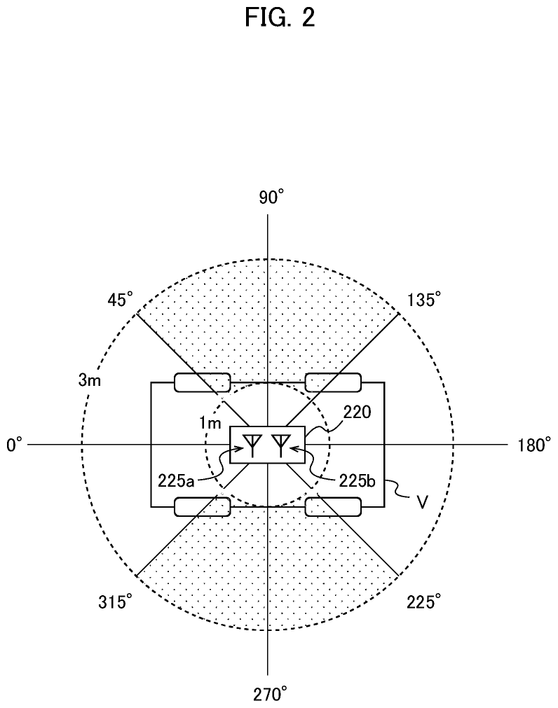

The following will describe the control by the on-vehicle device 20 according to the embodiment using concrete examples. FIG. 2 is a diagram for explaining an example of the control by the on-vehicle device 20 according to the embodiment.

FIG. 2 illustrates an arrangement example of the mobile body V and the two antenna elements 225a and 225b of the wireless communication unit 220 provided in the mobile body V.

As illustrated in FIG. 2, the antenna elements 225a and 225b of the embodiment may be arranged near the center of the mobile body V, with prescribed intervals along the advancing direction of the mobile body V. In FIG. 2, the advancing direction of the mobile body V is illustrated as 0°.

With such an arrangement, using the two antenna elements 225a and 225b, it is possible to estimate, with high accuracy, an angle of the portable device 10 existing on the side of the mobile body V, that is, near the doors of the driver's seat, the front passenger seat, and the rear seats, and effectively provide the user getting on the mobile body V with the functions in accordance with the angle of the portable device 10.

Moreover, FIG. 2 visually illustrates, with a dotted background, the conditions for the control unit 210 of the on-vehicle device 20 to cause a controlled device to perform a given operation.

For example, the control unit 210 of the embodiment may cause a controlled device to perform a given operation when the estimated angle of arrival (that is, the direction of the portable device 10 with the mobile body V as a reference) is in a range of 45° to 135° or 225° to 315°, and the obtained distance measurement value is in a range of 1 m to 3 m, as illustrated in FIG. 2.

With such control, it is possible to finely limit the position (direction and distance) of the portable device 10 as a condition for causing the controlled device to perform a given operation, and provide the user with various kinds of functions suitable for the position.

Note that the prescribed range related to the direction of the portable device 10 and the prescribed range related to the distance thereof may be determined on the basis of the other value for each other.

In the case of the arrangement of the antenna elements 225a and 225b illustrated in FIG. 2, the closer to the 0° direction or the 180° direction the angle of arrival is, the more difficult it is to obtain a phase difference. Thus, the estimation accuracy of the angle of arrival deteriorates.

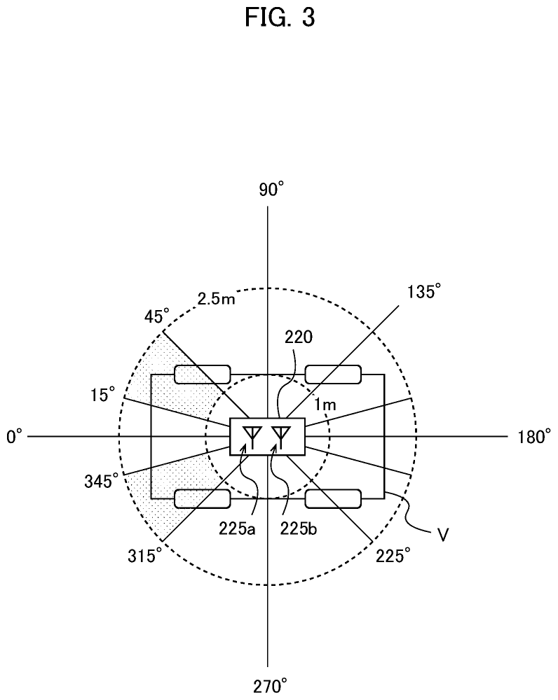

Therefore, for example, the control unit 210 may narrow the prescribed range related to the distance measurement value to a range of 1 m to 2.5 m when the angle of arrival (that is, the direction of the portable device 10 with the mobile body V as a reference) is in a range of 15° to 45° or 225° to 315°, as illustrated in FIG. 3.

In this manner, the control unit 210 of the embodiment may cause the controlled device to perform a given operation when the estimated distance of the portable device 10 is in a prescribed range determined in accordance with the direction of the portable device 10.

Conversely, the control unit 210 may cause the controlled device to perform a given operation when the estimated direction of the portable device 10 is in a prescribed range determined in accordance with the distance of the portable device 10.

With the above-described control, in accordance with one of the estimated direction and the estimated distance of the portable device 10, the condition for the other may be varied, thereby achieving more secure control.

The above has described the control by the control unit 210 using the concrete examples. Note that the above-described prescribed ranges are merely examples, and the prescribed ranges according to the embodiment may be appropriately set in accordance with specifications and uses.

Moreover, the arrangement of the antenna element 225 illustrated in FIGS. 2 and 3 is merely an example. For example, the on-vehicle device 20 of the embodiment may include a plurality of sets of at least two or more antenna elements for estimating an angle of arrival.

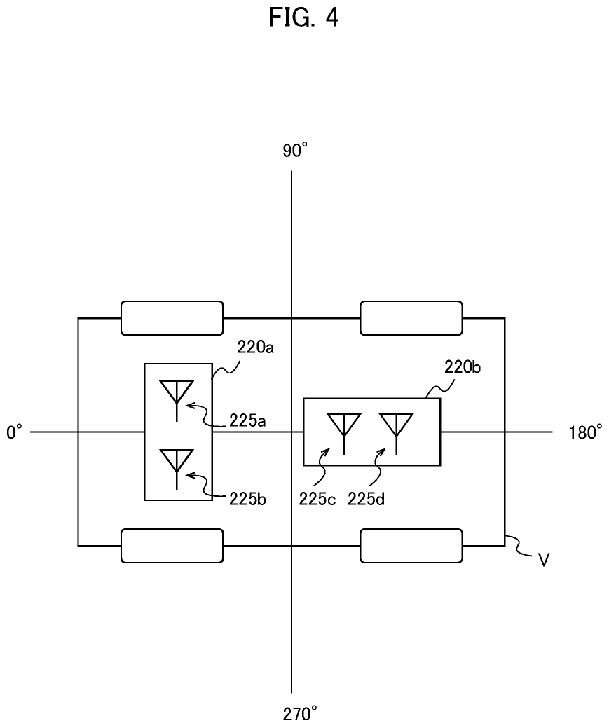

FIG. 4 is a diagram illustrating an arrangement example of the antenna element 225 according to the embodiment. In the case illustrated in FIG. 4, the on-vehicle device 20 includes two wireless communication units 220a and 220b.

Moreover, the wireless communication units 220a and 220b include a set of the two antenna elements 225a and 225b and a set of the two antenna elements 225c and 225d, respectively, the antenna elements being necessary for estimating an angle of arrival.

With such an arrangement, the closer to the 0° direction or the 180° direction the angle of arrival is, the easier it is to obtain a phase difference related to the antenna elements 225a and 225b. Thus, the accuracy of the angle of arrival estimated by the wireless communication unit 220a is improved. Similarly, the closer to the 90° direction or the 270° direction the angle of arrival is, the easier it is to obtain a phase difference related to the antenna elements 225c and 225d. Thus, the accuracy of the angle of arrival estimated by the wireless communication unit 220b is improved.

With the above-described arrangement, it is possible to estimate an angle of arrival with high accuracy, in all directions around the mobile body V, and achieve more secure control.

### <<1.3. Processing Flow>>

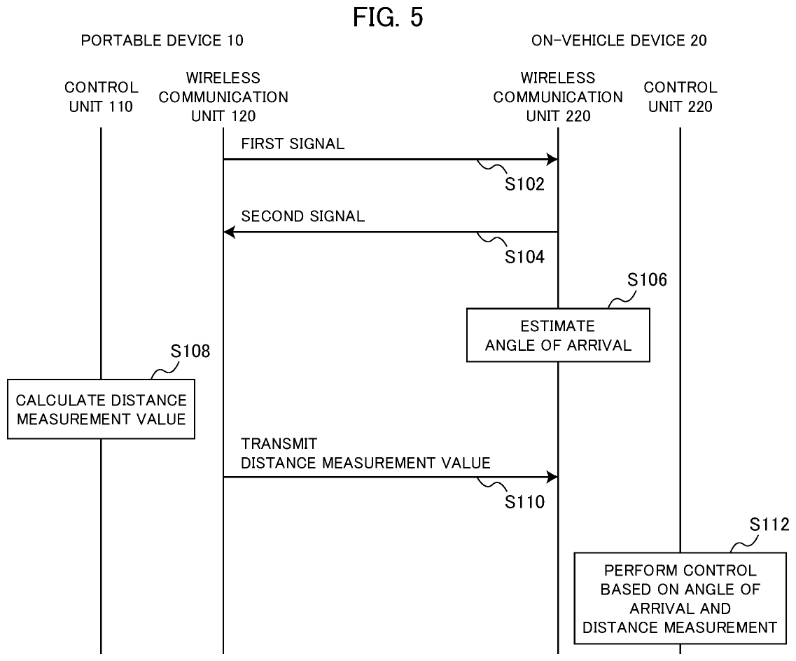

The following will specifically describe a flow of the processing by the system 1 according to the embodiment. FIG. 5 is a sequence diagram illustrating an example of a flow of the processing by the system 1 according to the embodiment

In the case of the example illustrated in FIG. 5, the wireless communication unit 120 of the portable device 10 first transmits a first signal (S102). The first signal is used for distance measurement and estimation of an angle of arrival.

Moreover, the first signal is received by two or more antenna elements 225 of the wireless communication unit 220 of the on-vehicle device 20.

Next, the wireless communication unit 220 of the on-vehicle device 20 transmits a second signal in response to the first signal received at Step S102 (S104). The second signal is used for distance measurement.

Moreover, the wireless communication unit 220 of the on-vehicle device 20 estimates an angle of arrival on the basis of a phase difference related to the first signal received by at least two antenna elements 225 at Step S102 (S106).

Meanwhile, the control unit 110 of the portable device 10 performs distance measurement based on the first signal transmitted by the wireless communication unit 120 at Step S102 and the second signal received by the wireless communication unit 120 at Step S104, and calculates a distance measurement value (S108).

Next, the wireless communication unit 120 transmits the distance measurement value calculated at Step S108 to the wireless communication unit 220 (S110).

Next, the control unit 210 of the on-vehicle device 20 performs a control based on the angle of arrival estimated at Step S106 and the distance measurement value received at Step S110 (S112).

The above has described the flow of the processing by the system 1 according to the embodiment using an example. Note that the above-described flow is merely an example, and the processing by the system 1 is not limited thereto.

For example, the above has exemplified the case in which the control unit 110 of the portable device 10 calculates a distance measurement value. However, the control unit 210 of the on-vehicle device 20 may calculate a distance measurement value according to the embodiment.

In this case, for example, the wireless communication unit 120 of the portable device 10 may transmit the information for calculating a distance measurement value (such as ΔT1 described above) to the wireless communication unit 220. Moreover, the wireless communication unit 220 may transmit a first signal, and the wireless communication unit 120 may transmit a second signal in response to the first signal.

Moreover, for example, the portable device of the portable device 10 may estimate a direction of the portable device 10 with the mobile body V as a reference. In this case, the wireless communication unit 220 of the on-vehicle device 20 may transmit the information for estimating the above-described direction (a phase difference, and various kinds of information for obtaining a phase difference, for example) to the wireless communication unit 120. The wireless communication unit 120 transmits the information of the estimated direction back to the wireless communication unit 220.

In this manner, the processing by the system 1 of the embodiment can be flexibly modified.

### <2. Supplement>

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

A sequence of processing by the devices described in this specification may be achieved using any one of software, hardware, and the combination of software and hardware. A program forming the software is preliminarily stored in a non-transitory computer readable medium provided inside or outside the devices, for example. Then, each program is read in a RAM when executed by a computer, and executed by a processor such as a CPU, for example. The above-described recording medium is, for example, a magnetic disk, an optical disk, a magneto-optical disk, a flash memory, or the like. Moreover, the above-described computer program may be distributed through a network, for example, without using any recording medium.

### REFERENCE SIGNS LIST

1 system
10 portable device
110 control unit
120 wireless communication unit
125 antenna element
20 on-vehicle device
210 control unit
220 wireless communication unit
225 antenna element

1. A control device, comprising:
a wireless communication unit that includes at least two antenna elements and performs wireless communication with another communication device; and
a control unit that controls a controlled device on the basis of a direction of the another communication device, the direction being estimated on the basis of the wireless communication, wherein
the control unit causes the controlled device to perform a given operation when the direction of the another communication device is within a prescribed range.

2. The control device according to claim 1, wherein the control unit causes the controlled device to perform a given operation when a distance to the another communication device estimated on the basis of the wireless communication is within a prescribed range.

3. The control device according to claim 2, wherein the control unit causes the controlled device to perform a given operation when the estimated distance to the another communication device is within a prescribed range that is determined in accordance with the estimated direction of the another communication device.

4. The control device according to claim 2, wherein the control unit causes the controlled device to perform a given operation when the estimated direction of the another communication device is within a prescribed range that is determined in accordance with the estimated distance to the another communication device.

5. The control device according to claim 1, wherein
the wireless communication unit estimates, on the basis of a signal from the another communication device that is received by the at least two antenna elements, an angle of arrival of the signal, and
the control unit causes the controlled device to perform a given operation when the angle of arrival is within a prescribed range.

6. The control device according to claim 1, wherein the control device is provided in a mobile body.

7. The control device according to claim 6, wherein the at least two antenna elements are arranged around a center of the mobile body.

8. The control device according to claim 6, wherein the at least two antenna elements are arranged with prescribed intervals along an advancing direction of the mobile body.

9. The control device according to claim 1, wherein the wireless communication unit performs ultra-wideband wireless communication with the another communication device.

10. A system, comprising:
a control device; and
a communication device, wherein
the control device includes
a wireless communication unit that includes at least two antenna elements and performs wireless communication with the communication device, and
a control unit that controls a controlled device on the basis of a direction the communication device, the direction being estimated on the basis of the wireless communication, and
the control unit causes the controlled device to perform a given operation when the direction of the communication device is within a prescribed range.
